(19) United States
(12) Patent Application Publication
(10) Pub. No.: US 2023/0339093 A1
(43) Pub. Date: Oct. 26, 2023

(54) ACCESSORY FOR GRIP HANDLE WITH ROTATING FERRULE

(71) Applicant: OPINEL SAS, Chambery (FR)

(72) Inventor: François OPINEL, CHAMBERY (FR)

(73) Assignee: OPINEL SAS, CHAMBERY (FR)

(21) Appl. No.: 18/139,107

(22) Filed: Apr. 25, 2023

(30) Foreign Application Priority Data
Apr. 25, 2022 (FR) 22/03804

(51) Int. Cl. B25G 1/06

(52) U.S. Cl. CPC B25G 1/06

(57) ABSTRACT

An accessory suitable for a removable attachment in a grip handle, in which the handle includes an inner housing formed in an end portion of the grip handle, an opening whose second portion opens onto a lateral side of the grip handle, a rotating ferrule rotating between a blocking position, in which the rotating ferrule at least partly covers the second portion of the opening, and a release position, in which the rotating ferrule releases the second portion of the opening. The accessory includes an assembly portion usable as a removable attachment of the accessory to the grip handle. The assembly portion is inserted into the inner housing, and includes a retaining part that cooperates with the rotating ferrule when the rotating ferrule is in the blocking position so as to retain the assembly portion in the inner housing.

### CROSS-REFERENCE TO RELATED APPLICATIONS

This application claims priority to and the benefit of FR 22/03804 filed on Apr. 25, 2022. The disclosure of the above application is incorporated herein by reference.

### FIELD

The present disclosure relates to the field of interchangeable accessories intended to be inserted into grip handles or knives.

### BACKGROUND

The statements in this section merely provide background information related to the present disclosure and may not constitute prior art.

Several types of grip handle or hand instruments provided with different accessories or tools are known, and in particular an instrument including on the one hand a handle and on the other hand various tools that are movable or detachable with respect to the handle. For example, the best known is a hand instrument usually called by the expression “Swiss knife”, including a block forming a handle. On the latter, several tools such as scissors, file, blade, punch, screwdriver, corkscrew, USB key, etc. are mounted in an articulated manner along a transverse axis. This type of knife has advantages in that it combines in a single instrument several tools with various respective functionalities. However, their structure is relatively complex given the constraints of solidity and resistance linked to the presence of several tools mounted in rotation, which leads to high weight and a high manufacturing cost.

Thus, it is found that known hand instruments or grip handles have at least one, or even two or more of the following drawbacks: complex construction; high manufacturing cost; significant weight; difficult handling and installation of accessories (tools for example); inconvenient handling of the handle (direction transverse to the handle); attachment or location of the accessory (for example screwdriver) outside periods of use, inconvenient or resulting in complex structures.

### SUMMARY

This section provides a general summary of the disclosure and is not a comprehensive disclosure of its full scope or all of its features.

In particular, the present disclosure provides accessories, such as kitchen utensils, bivouac tools, etc. configured to be removably attached to grip handles. The present disclosure also proposes an assembly including a handle and one or more accessories that can form an accessory kit.

The present disclosure proposes an accessory suitable for removable attachment in a grip handle, the grip handle comprising:
an inner housing formed in an end portion of the grip handle, the inner housing including an opening whose first portion opens into an end face of the handle and whose second portion opens onto a lateral side of the grip handle, the end face extending transversely to the direction of longitudinal extension of the grip handle,
a rotating ferrule rotatably mounted between a blocking position in which the rotating ferrule at least partially covers the second portion of the opening and a release position in which the rotating ferrule releases the second portion of the opening,
the accessory comprising an assembly portion configured for removable attachment of the accessory to the grip handle, the assembly portion being configured to be inserted into the inner housing, and comprising a retaining part configured to cooperate with the rotating ferrule when the rotating ferrule is in the blocking position so as to retain the assembly portion in the inner housing.

It is then possible to fit a multitude of accessories on a single handle. This reduces the weight of the equipment to be carried while increasing comfort of use. The accessory can be a kitchen utensil, such as a spatula; cutlery, for example a fork or a spoon; a tool such as an awl, a screwdriver, a corkscrew; or any other function.

The cooperation between the retaining part of the accessory and the rotating ferrule makes it possible not only to provide the attachment of the accessory to the handle but also to offer advantages of use: when the rotating ferrule is in the blocking position, the accessory can be handled properly.

According to one form, the retaining part comprises a prominence configured to be received in a circumferential groove formed on an inner surface of the rotating ferrule, so as to retain the assembly portion when the rotating ferrule is in the blocking position.

According to one form, the assembly portion comprises an insertion part configured to be received in the inner housing. The insertion part thus completes the retaining part for the removable attachment of the accessory in the grip handle.

In one form, the insertion part longitudinally extends in the main direction of extension of the accessory so as to form a guide lug when inserting the assembly portion into the inner housing. This variation provides an angular anti-sloshing system for the accessory inserted into the handle when using the accessory.

According to one form, the assembly portion has a thickness less than the width of the inner housing, the assembly portion comprising a transverse portion defining a protrusion on an upper face, the protrusion being configured to bear on a first inner face of the inner housing and delimits on an opposite lower face of the assembly portion a cavity extending between two bearing parts, the two bearing parts being configured to bear against a second inner face of the inner housing opposite the first inner face. This variation avoids excessive angular movement of the accessory fixed in the grip handle and facilitates its use.

According to one form, the grip handle includes a pivoting blade and a longitudinal groove formed from the end face and comprising a slot whose portion is common with the opening of the inner housing, the pivoting blade comprising a portion pivotally mounted in the longitudinal groove for pivoting the pivoting blade between a retracted position in which the pivoting blade is housed in the longitudinal groove, in which the rotating ferrule blocks the pivoting blade when the rotating ferrule is in the blocking position and in which the inner walls of the longitudinal groove and the pivoting portion define the contours of the inner housing, and a position of use in which the pivoting blade extends out of the longitudinal groove, in the longitudinal direction of the handle, and the assembly portion comprises an indentation part delimited by the insertion part on the one hand and by the retaining part on the other hand, the indentation part being configured to have a shape complementary to the pivoting portion for an interlocking with the pivoting portion in the inner housing when the assembly portion is inserted into the inner housing. The rotating ferrule is in the blocking position. The size of the assembly portion inserted into the inner housing is limited. The accessory slightly protrudes from the handle while remaining stable for optimal use of the functional portion. The functional portion being the portion that will be used by the user. For example, when the accessory is a cutlery, such as a fork, the functional portion is the fork with pointed ends. For a spoon, the functional portion is the hollow and concave end forming the bowl.

In this variation, “rotating ferrule” is defined as a ring comprising a fixed part fixed to the grip handle and a rotary part allowing the blade to be blocked in the open position and the blade to be blocked in the closed position, the accessory being inserted and fixed in the handle.

According to one form, the accessory is configured to be hooked to an additional accessory, the accessory comprising a hooking means configured to cooperate with a complementary hooking means provided on the additional accessory, so as to allow the hooking of the accessory to the additional accessory. This variation facilitates the storage of unused accessories.

According to another form, the present disclosure proposes a kit of accessories comprising an additional accessory comprising complementary hooking means and an accessory as described above.

According to one form, the hooking means and the complementary hooking means are configured so that the assembly portions and functional portions respectively of the accessory and of the additional accessory are superimposed when the hooking means is hung by means of complementary hook. Thus, when the functional portions have complementary shapes, the superposition leads to a minimal bulk of the accessory kit.

According to one form, the hooking means comprises a lug, in particular made in a connecting portion of the accessory connecting the assembly portion to the functional portion of the accessory.

Conversely, the additional hooking means comprises a through lumen, in particular formed in a connecting portion configured to connect the assembly portion to a functional portion of the additional accessory.

According to yet another form, the present disclosure proposes an assembly comprising a grip handle, the grip handle including:
an inner housing formed in an end portion of the grip handle, the inner housing including an opening whose first portion opens into an end face of the handle and whose second portion opens onto a lateral side of the grip handle, the end face extending transversely to the direction of longitudinal extension of the grip handle,
a rotating ferrule rotatably mounted between a blocking position in which the rotating ferrule at least partly covers the second portion of the opening and a release position in which the rotating ferrule releases the second portion of the opening, and
the assembly further comprising at least one accessory as previously described or a kit of accessories also described above.

According to one form, the grip handle of said assembly includes a pivoting blade and a longitudinal groove formed from the end face and comprising a slot, one portion of which is common with the opening of the inner housing, the pivoting blade comprising a portion pivotally mounted in the longitudinal groove for pivoting the pivoting blade between a retracted position in which the pivoting blade is housed in the longitudinal groove, in which the rotating ferrule blocks the pivoting blade when the rotating ferrule is in the blocking position and in which the inner walls of the longitudinal groove and the pivoting portion define the contours of the inner housing, and a position of use in which the pivoting blade extends outside the longitudinal groove, in the longitudinal direction of the grip handle.

According additional forms, the accessory and the accessory kit includes one or more of the following optional characteristics, which may be implemented alone or in any combination: the lateral side of the grip handle extends in the longitudinal extension direction of the grip handle; the assembly portion is mostly flat; the retaining part extends mainly longitudinally according to the main direction of extension of the accessory; he prominence of the retaining part extends in a direction transverse to the main direction of extension of the accessory; the length of the insertion part is longer than that of the retaining part; the insertion part, the cutout and the retaining part are configured so that the retaining part is inserted from the side of the second portion of the opening of the inner housing and the insertion part is inserted from the opposite side at the second portion of the opening; the retaining part is inserted into the inner housing from the side of the second portion of the opening of the inner housing; the indentation part has a shape complementary to that of the inner housing; the protrusion of the transverse portion is obtained by embossing the assembly portion; the protrusion is radial; the transverse portion is part of the assembly portion deformed by impact; one of the bearing parts located in the end region of the assembly portion forms the retaining part; the assembly portion is made of metal; and the accessory is mainly made of metal, for example stainless steel.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a schematic front view of an accessory according to one form of the present disclosure;

FIG. 2 represents a schematic profile view of the accessory in FIG. 1;

FIG. 3 represents a schematic front view of an additional accessory according to one form of the present disclosure;

FIG. 4 represents a schematic view of a kit of an accessory and of an additional accessory and of the hooking means according to one form of the present disclosure;

FIG. 5 represents a schematic view of the kit of FIG. 4;

FIG. 6 represents a cross-sectional view of an accessory inserted into a handle; and

FIG. 7 represents another cross-sectional view opposite to that of FIG. 6 of the accessory inserted into a handle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

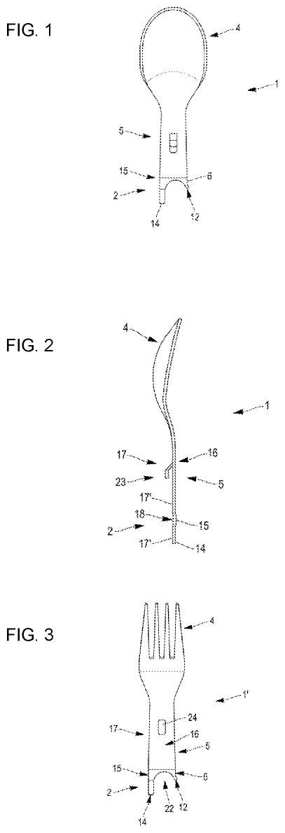

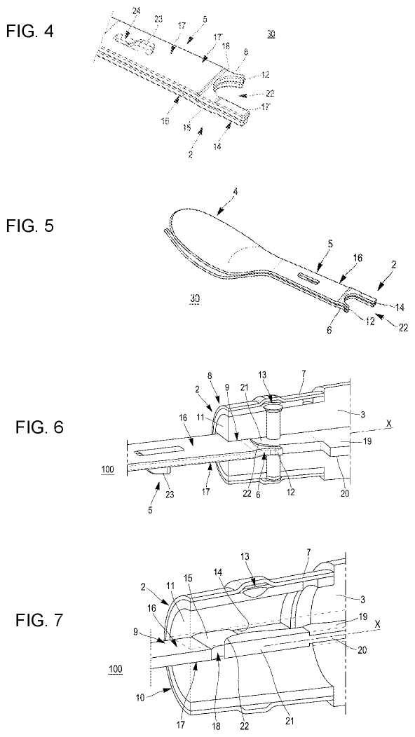

As illustrated in FIGS. 1 to 3, an accessory 1 according to the present disclosure comprises an assembly portion 2 intended for removable attachment in a grip handle 3 (FIGS. 6 and 7), a functional portion 4, here the bowl or the fork, and a connecting portion 5 connecting the other two portions 3, 4. The assembly portion 2 includes a retaining part 6 (also visible in FIGS. 4 and 5, configured to cooperate with a rotating ferrule 7 provided on the grip handle 3 as will be seen below (FIGS. 6 and 7), so as to retain the assembly portion 2 in the handle 3.

The grip handle 3 comprises, in an end portion 8, an inner housing 9 (FIGS. 6 and 7) including an opening 10 which is used in particular for the introduction of the assembly portion 2 of the accessory 1. More specifically, the opening 10 comprises a first portion opening into an end face 11 of the grip handle 3 and from which the connecting portion 5 and the functional portion 4 protrude when the assembly portion 2 is inserted. The end face 11 extends transversely to the direction X of longitudinal extension of the grip handle 3. The opening 10 also comprises a second portion opening onto a lateral side of the handle 3 and which allows a prominence 12 provided in the retaining part 6 for cooperation with the rotating ferrule 7.

The rotating ferrule 7 of the handle is rotatably mounted between a blocking position in which the rotating ferrule 7 at least partly covers the second portion of the opening 10 and a release position in which the rotating ferrule 7 releases the second portion of the opening 10. The prominence 12 of the retaining part 6 of the accessory 1 is configured to be received in a circumferential groove 13 provided on an inner surface of the rotating ferrule 7, so as to retain the assembly portion 2 in the inner housing 9 when the rotating ferrule 7 is in the blocking position (FIGS. 6, 7).

Also illustrated in the figures, the assembly portion 2 comprises an insertion part 14 configured to be received in the inner housing 9. It longitudinally extends along the main direction of extension of the accessory 1, so as to form a guide lug when inserting the assembly portion 2 into the inner housing 9. This facilitates the insertion into the housing 9 and also provides an angular anti-sloshing effect of the accessory 1 inserted into the handle 3. The insertion part 14 thus confers good rigidity on the assembly 100 of the accessory 1 housed in the grip handle 3.

In parallel, the assembly portion 2 has a thickness less than the width of the inner housing 9, which facilitates the insertion but to compensate for this dimensional play that can interfere with the use of the accessory 1, the assembly portion 2 comprises a transverse portion defining a protrusion 15 on an upper face 16 which makes it possible to bear against a first inner face of the inner housing 9. Reciprocally, the protrusion 15 delimits on an opposite lower face 17, a cavity 18 extending between two bearing parts 17′ which allow a bearing on a second opposite inner face. Thus, during the insertion into the housing, the assembly portion thinner than the opening 10 of the inner housing 9 is guided by the guide lug, then the protrusion 15 bears on a first inner face and the two bearing parts, formed by two regions 17′ of the lower face 17 (FIG. 2), bear on a second opposite inner face which limits the angular deflections of the assembly portion 2 inserted into the inner housing 9.

In the variation of the present disclosure where the grip handle 3 comprises a pivoting blade 19 (illustrated in FIGS. 6 and 7), a longitudinal groove 20 is formed from the end face 11 of the grip handle 3, comprising a slot, a portion of which is common with the opening 10 of the inner housing 9. Specifically, the pivoting blade 19 comprises a pivoting portion 21 pivotally mounted in the longitudinal groove 20. This provides the pivoting of the pivoting blade 19 between a retracted position in which the pivoting blade 19 is housed in the longitudinal groove 20 (illustrated in FIGS. 6 and 7), and a position of use in which the pivoting blade 19 extends out of the longitudinal groove 20, in the longitudinal direction X of the handle 3 (not shown).

In the retracted position of the pivoting blade 19, the inner walls of the longitudinal groove 20 and the pivoting portion 21 define the contours of the inner housing 9 capable of receiving the accessory 1. In parallel, the assembly portion 2 comprises an indentation part 22, delimited on either side of the insertion part 14 and of the retaining part 6, which has a shape complementary to that of the pivoting portion 21 so as to allow an interlocking with the pivoting portion 21 when the assembly portion 2 is inserted into the inner housing 9.

In the variation where the grip handle 3 does not have a pivoting blade 19, the accessory 1 also comprises an indentation part 22 of a shape complementary to the shape of the inner housing 9.

As illustrated in FIGS. 1 to 5, the accessory 1, such as a spoon (FIGS. 1 and 2), is configured to be hooked by overlapping with an additional accessory 1′ (here a fork—FIG. 3) by a hooking means 23 formed in the connecting part 5 of the accessory 1, wherein the hooking means 23 in this form is a lug (FIGS. 2 and 4). The hooking means 23 is configured to cooperate with a complementary hooking means 24, illustrated here by a through lumen (FIG. 3) provided on the additional accessory 1′. When the shape of the assembly portions 2 and the functional portion 4 and connecting portions 5 of the accessory 1 and of the additional accessory 1′ are complementary, the latter two cling together (FIGS. 4 and 5) and form a kit 30.

In use, when the rotating ferrule 7 is in the release position, the pivoting blade 19 can pivot in the retracted position in the longitudinal groove 20, and the assembly portion 2 of the accessory 1 can be inserted into the inner housing 9, for example until the indentation part 22 comes into abutment against the pivoting portion 21. The retaining part 6 is arranged on the side of the second portion of the opening 10 of the housing 9 in order to be able to cooperate with the rotating ferrule 7. The rotating ferrule 7 can then rotate from its release position to its blocking position in which the circumferential groove 13 cooperates with the prominence 12 of the retaining part 6 so as to fix the accessory 1 in the grip handle 3. At the same time, the rotating ferrule 7 blocks the pivoting blade 19 in its retracted position. To use the pivoting blade 19 or inter-change accessory 1, for example, the rotating ferrule 7 is moved from its blocking position to its release position. The retaining part 6 is then arranged in front of a slot of the rotating ferrule 7 juxtaposed with the longitudinal groove 20 so that it is possible to remove the accessory 1 from the inner housing 9. The pivoting portion 21 of the pivoting blade 19 being released from the indentation part 22, and being opposite the slot of the rotating ferrule 7, the blade 19 can pivot into its position of use, in which it extends out of the longitudinal groove 20, in the longitudinal direction X of the handle 3.

Thus, the present disclosure proposes an accessory 1 for removable attachment in a grip handle 3 cleverly designed to be easily inserted into the handle 3. The accessory 1 is also well thought out to provide stability in the handle 3 avoiding axial or angular displacement when using it. The fact of using a rotating ferrule 7 also makes it possible to secure the use of the accessory 1 received in the handle 3. In addition, the hooking means 23, 24 provided on the accessory 1 and the additional accessory 1′ allows optimal storage, limiting the size of the kit 30.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An accessory configured to be a removable attachment in a grip handle, the grip handle comprising:
an inner housing formed in an end portion of the grip handle, the inner housing including an opening having a first portion opening into an end face of the grip handle and a second portion opening onto a lateral side of the grip handle, the end face extending transversely to the direction of longitudinal extension of the grip handle,
a rotating ferrule rotatably mounted between a blocking position in which the rotating ferrule at least partially covers the second portion of the opening and a release position in which the rotating ferrule releases the second portion of the opening,
the accessory comprising an assembly portion configured for a removable attachment of the accessory to the grip handle, the assembly portion being configured to be inserted into the inner housing, and comprising a retaining part configured to cooperate with the rotating ferrule when the rotating ferrule is in the blocking position so as to retain the assembly portion in the inner housing.

2. The accessory according to claim 1, wherein the retaining part comprises a prominence configured to be received in a circumferential groove provided on an inner surface of the rotating ferrule, to the prominence retaining the assembly portion when the rotating ferrule is in the blocking position.

3. The accessory according to claim 1, wherein the assembly portion comprises an insertion part operable to be received in the inner housing.

4. The accessory according to claim 3, wherein the insertion part extends longitudinally along the main direction of extension of the accessory so as to form a guide lug during the insertion of the assembly portion into the inner housing.

5. The accessory according to claim 1, wherein the assembly portion has a thickness less than the width of the inner housing, the assembly portion comprising a transverse portion defining a protrusion on an upper face, the protrusion being operable to bear on a first inner face of the inner housing and delimit a lower face opposite the assembly portion, and a cavity extending between two bearing parts, the two bearing parts being operable to bear against a second inner face of the inner housing opposite the first inner face.

6. The accessory according to claim 1, the grip handle including a pivoting blade and a longitudinal groove formed from the end face and comprising a slot, a portion of the slot being common with the opening of the inner housing, the pivoting blade comprising a pivoting portion pivotally mounted in the longitudinal groove for the pivoting of the pivoting blade between:
a retracted position in which the pivoting blade is housed in the longitudinal groove, in which the rotating ferrule blocks the pivoting blade when the rotating ferrule is in the blocking position and in which the inner walls of the longitudinal groove and the pivoting portion define contours of the inner housing; and
a position of use in which the pivoting blade extends out of the longitudinal groove, in the longitudinal direction of the grip handle;
wherein the assembly portion comprises an indentation part delimited by the insertion part and the retaining part, the indentation part being operable to have a shape complementary to the pivoting portion for an interlocking with the pivoting portion in the inner housing when the assembly portion is inserted into the inner housing.

7. The accessory according to claim 1, the accessory being configured to be hooked to an additional accessory, the accessory comprising a hooking means configured to cooperate with additional hooking means provided on the additional accessory, so as to allow hooking of the accessory to the additional accessory.

8. An accessory kit comprising an additional accessory comprising additional hooking means and an accessory according to claim 7.

9. The accessory kit according to claim 8, wherein the hooking means and the additional hooking means are configured so that the assembly portions and functional portions, respectively, of the accessory and of the additional accessory are superposed when the hooking means is hooked to the additional hooking means.

10. An assembly comprising a grip handle, the grip handle including:
an inner housing formed in an end portion of the grip handle, the inner housing including an opening whose first portion opens into an end face of the grip handle and whose second portion opens onto a lateral side of the grip handle, the end face extending transversely to the direction of longitudinal extension of the handle;
a rotating ferrule rotatably mounted between a blocking position in which the rotating ferrule at least partially covers the second portion of the opening and a release position in which the rotating ferrule releases the second portion of the opening; and
at least one accessory according to claim 1.

11. An assembly comprising a grip handle, the grip handle including:
an inner housing formed in an end portion of the grip handle, the inner housing including an opening whose first portion opens into an end face of the grip handle and whose second portion opens onto a lateral side of the grip handle, the end face extending transversely to the direction of longitudinal extension of the handle;
a rotating ferrule rotatably mounted between a blocking position in which the rotating ferrule at least partially covers the second portion of the opening and a release position in which the rotating ferrule releases the second portion of the opening; and
at least one accessory kit comprising:
an assembly portion configured for a removable attachment of the accessory to the grip handle, the assembly portion being configured to be inserted into the inner housing, and comprising a retaining part configured to cooperate with the rotating ferrule when the rotating ferrule is in the blocking position so as to retain the assembly portion in the inner housing,
the accessory kit being configured to be hooked to an additional accessory, the accessory kit comprising a hooking means configured to cooperate with additional hooking means provided on the additional accessory, so as to allow hooking of the accessory to the additional accessory.
